(19) United States
(12) Patent Application Publication
(10) Pub. No.: US 2012/0151153 A1
(43) Pub. Date: Jun. 14, 2012

(54) Programmable Controller

(75) Inventors: Axel Jantsch, Akersberga (SE); Lu Zhonghai, Kista (SE); Chen Xiaowen, Kista (SE); Ahmed Hemani, Taby (SE)

(73) Assignee: Axel JANTSCH, Akersberga (AT)

(21) Appl. No.: 13/381,614

(22) PCT Filed: Jul. 3, 2009
(86) PCT No.: PCT/SE09/50872

§ 371 Date: Feb. 22, 2012

(51) Int. Cl. G06F 12/00

(52) U.S. Cl. 711/147; 711/100; 711/E12.001

(57) ABSTRACT

A controller is provided which comprises one or more processors, a control store, a first interface control unit for interfacing a local core and a second interface control unit for interfacing one or more remote cores via an interconnect, wherein the processor/s discloses programmable mini-processor/s is adapted to execute, add, remove or modify a function by executing micro-code maintained typically in the local memory but also possibly in remote, or even off-chip memory, and obtained via the control store, in response to receiving a command from the first or the second interface control unit.

### TECHNICAL FIELD

The present document relates to a programmable controller that is suitable for implementation on an on-chip multi-core computing platform or system, and a method for applying command triggered micro-code on such a controller.

### BACKGROUND

The concept of applying processing of micro-code on computing platforms and systems is a well known approach for providing more flexibility to the platform or system.

U.S. Pat. No. 5,212,631 A and U.S. Pat. No. 5,265,005 A refer to two similar programmable controllers that are both adapted for operating industrial equipment, and more specifically, for operating processors which execute a user defined control program in the programmable controller. This is achieved by multiple instruction execution sections, which are adapted to perform different operations simultaneously. By way of using command message frames, these sections can make the programmable controller to respond to requests received from external devices. However, commands are only used to enable dialogues with external devices.

Also Distributed Shared Memory (DSM) has a long history of providing implementations, in which a number of nodes have access to shared memory space, in addition to the non-shared memory of each node.

However, current approaches for supporting DSM in multi-core computing platforms and systems rely either on a software, or on a hardware approach.

### SUMMARY

The claimed invention refers to a programmable, or micro-coded, controller which has been adapted to support DSM related functions, such as e.g. virtual-to-physical (V2P) address translation, local and remote memory access, memory synchronisation, as well as cache coherency and memory consistency. In addition, the controller also supports explicit Message Passing (MP) for inter-process communication, without requiring any involvement of shared variables.

A programmable implementation can optimize the communication of messages transparent to the user of the service. In particular the amount and location of buffering of the message can be decided by the programmable message passing service. In some cases no buffering is needed at all, which greatly reduces latency and power consumption. In other cases the buffering can be done at the receiver's node, which can potentially hide the latency of message transfer from both the sender and the receiver. A sophisticated micro-program may do these optimizations adaptively at run-time by using information about message size, message transfer rate and deadlines. This type of information is in many cases not available at design time. Due to its flexibility, a programmable message passing realization allows for these and other dynamic optimizations and adaptations, which are impossible in corresponding configurations that are based on pure hardware solutions.

The suggested programmable controller has an architecture which is re-usable for different applications, DSM and/or MP architectures, thereby providing for more flexible solutions.

The programmable controller is adapted to support a partitioned address space with one physical address part, and another virtual address part, and may also be adapted to handle shared variable synchronisation, if the programmable controller is provided with more than two processors.

The suggested micro-programmable architecture is also inherently easier to develop than corresponding hardware architectures, since it facilitates maintenance and allows for easy field upgrading, e.g. when an algorithm of an application is to be changed.

Furthermore, the programmable controller architecture is also adapted to be used together with a command triggered micro-code method, which relies on micro-code that may be specialized for different types of customized applications which are based on a DSM and/or MP architecture.

According to one aspect a controller comprising a processor, a control store, a first interface control unit for interfacing a local core, and a second interface control unit for interfacing one or more remote cores via an interconnect is provided. The processor, which is a programmable processor, is adapted to execute, add, remove or modify a function by executing associated micro-code that is obtained via the control store, in response to receiving a command from one of the interface control units.

Each of the commands, which are used as triggers of the controller, corresponds to an associated programmable micro-code, while a piece of programmable micro-code corresponds to one or more executable micro-instructions.

When used at the controller a set of executable micro-instructions have been defined to implement or activate a specific function, such as e.g. a memory management function which supports Distributed Shared Memory (DSM) and/or Message Passing (MP).

Functions that are to be applied on the controller may relate to one or more of local and remote memory access, synchronisation, cache coherence, memory consistency and/or virtual-to-physical (V2P) address translation.

The first interface control unit and the second interface control unit are typically adapted to upload an executable micro-code from the local memory to the control store in response to having received a corresponding command at the respective interface control unit.

In order to enable the control units to determine whether an executable micro-code is available at the control store, the first interface control unit, as well as the second first interface control unit may further be provided with a respective table, here referred to as a Command Look-up Table (CLT), which can be checked by the respective control unit. Such a CLT typically comprises an identifier, which identifies a command, and a start address, which indicates where the micro-code associated with an identified command is located in the control store.

In case the executable micro-code is not already stored at the control store, the interface control units may be adapted to upload executable micro-code to the control store from one or more of: the local memory of the controller, a memory of a remote node or from an off-chip memory.

More specifically the first interface control unit may be adapted to forward commands received from the main core of a first node, while the second interface control unit may instead be adapted to forward commands received from a node other than the first node, i.e. from a remote node.

According to an alternative embodiment, the controller may comprise a first programmable processor, which is inter-connected to the first interface control unit, and a second programmable processor, which is inter-connected to the second interface control unit.

When implemented according to any of the suggested embodiments, the first programmable processor and/or the second programmable processor may be a mini-processor.

In order to manage a dual processor configuration the programmable controller may also comprise a synchronisation unit, or a synchronisation supporter, which is adapted to coordinate the programmable processors of the controller, by way of serializing recognized commands that are simultaneously requesting memory access to the same memory region.

A programmable controller may be implemented on one or more nodes of an on-chip system, a multi-core computing platform, or a multi-core computer.

According to another aspect, a method at a controller according to any of the embodiments described above, is also provided, wherein the programmable processor of such a controller is adapted to perform a series of steps in order to provide for a flexible controller.

In a first step either the first interface control unit or the second interface control unit receives a command that triggers executing, adding, removing or modifying of a function at the processor. In response to such a command the processor obtains programmable micro-code that is corresponding to the command from a control store. In a next step the micro-code is executed by the processor, such that a specific function is executed, added, removed or modified at the controller.

In case the executable micro-code is not already stored in the control store, a further step of uploading the one or more executable micro-code to the control store from any of the local memory of the controller, a memory of a remote node, or from an off-chip memory, may be performed by the processor.

The step of obtaining executable micro-code will typically be executed by generating the one or more addresses required to fetch the relevant micro-instructions.

In case there is no space available for uploading the micro-instructions to the control store, when a command has been received and recognized by a control unit, a further step of activating a replacement policy that has been configured to replace micro-code presently stored in the control store with the micro-code that corresponds to the command may be applied.

The executing step may comprise the step of executing a function which relates to any of local and remote memory access, synchronisation, cache coherency, memory consistency, or virtual-to-physical (V2P) address translation. Alternatively, this step may relate to execution of a function which relates to any of open, close, or query communication channel, or send or receive a message.

Alternatively the programmable controller may comprise a first programmable processor inter-connected to the first interface control unit, and a second programmable processor, inter-connected to the second interface control unit. In such a case the suggested method may be executed on any of the processors.

In case the programmable controller is provided with two processors and in case different commands that are simultaneously requesting access to the same memory region are received by the controller, a serializing step for serializing memory access requests may be applied, thereby allowing synchronisation of the different commands at the controller.

The step of obtaining executable micro-code may further comprise a determining step for determining whether the executable micro-code is presently available at the local control store by checking a CLT, the determining step being executed at the first interface control unit, or at the second first interface control unit.

The suggested micro-code programming method enables implementation of different algorithms for the same function, and programming to be done at run-time, thereby also enabling an application to use its own set of optimized micro-programs. The suggested method enables application programmers to execute, add, modify and remove functions, so that they may suit a present application, without having to replace any chip, and without having to re-design the Printed Circuit Board (PCB) on which the controller is implemented.

The suggested programmable controller may be implemented in any type of embedded multi-core computer, which is developed for applications, such as e.g. multimedia, gaming, as well as in set-top-boxes, mobile computing platforms, GSP processors, or any other type of packet-, image, graphics and/or audio processor. In addition, the programmable controller may even be a part of a general purpose multi-core computing system that has been designed for desktop applications, as well as file-, mail- and database servers.

### BRIEF DESCRIPTION OF THE DRAWINGS

The present invention will now be described in more detail by means of exemplary embodiments and with reference to the accompanying drawings, in which:

FIG. 1 is a system architecture, illustrating a multi-core computing platform that is suitable for implementation of a programmable controller.

FIG. 2 is a block diagram, illustrating an architecture of a programmable controller, according to one exemplary embodiment.

FIG. 3 is a block diagram, illustrating an alternative architecture of a programmable controller, according to another exemplary embodiment.

FIG. 4 is a flow chart, illustrating normal operation of a programmable controller that has been adapted according to the present document.

FIG. 5 is a schematic overview of a memory space partitioning that enables memory to be shared between a plurality of nodes.

FIG. 6 is a schematic overview of a V2P translation table, suitable for use by a programmable controller.

### DETAILED DESCRIPTION

The general concept of the present document is directed to a controller that is suitable for supporting DSM on a multi-core computing platform.

The suggested controller is adapted to realize basic DSM functions, such as e.g. memory allocation and de-allocation, memory read, memory write and V2P translation, as well as to support advanced DSM functions, such as e.g. cache coherency and memory consistency.

The controller is also adapted to realize conventional Message Passing (MP) functions, such as e.g. open channel, blocking and non-blocking send, blocking and non-blocking receive, close channel, and query channel.

In order to overcome at least some of the deficiencies mentioned above, the controller has been adapted to be operable as a programmable controller, offering a flexible solution as to implementations and modifications of the applied functions in general, and especially to DSM and or MP related functions. More specifically, the suggested programmable controller refers to a controller that is re-usable across different types of computing platforms and systems, enabling re-programming possibilities for customization and optimization of different applications.

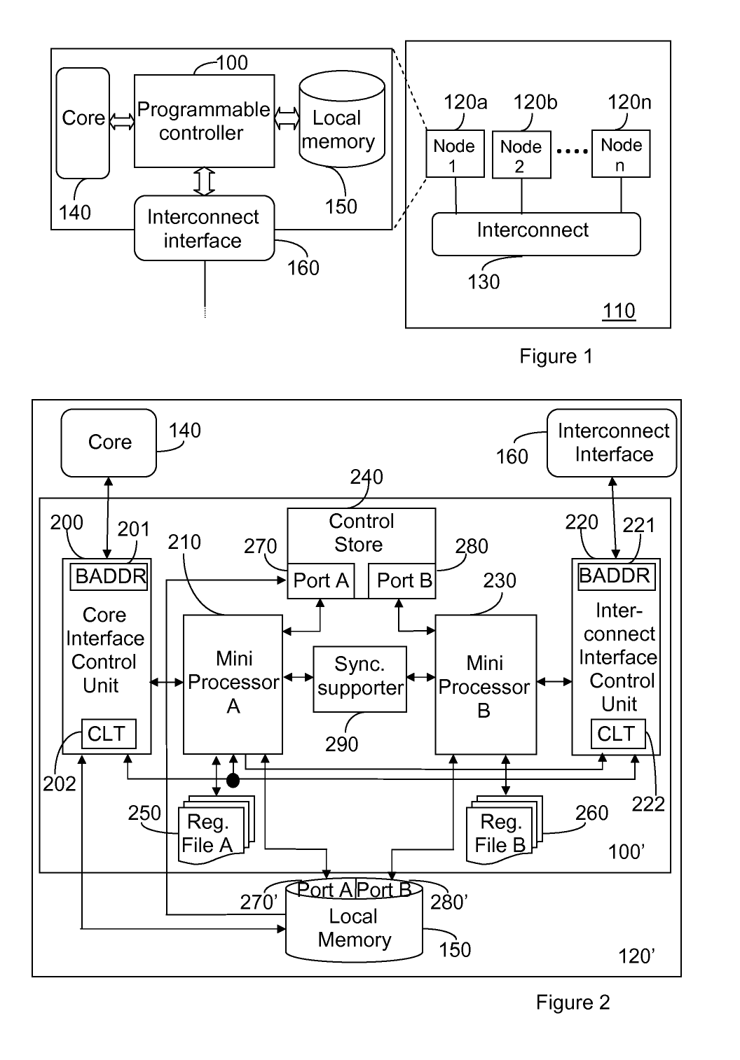

FIG. 1 is a simplified overview of a typical implementation of a programmable controller 100, where a multi-core computing platform 110, comprises a plurality of nodes, referred to as node 1 120a-node n 120n, each of which is inter-connected to each other via one or more buses and/or networks, which in this example is represented by interconnect 130. Each node 120a-120n, comprises a core 140, which is typically a CPU with or without a cache, and which may be implemented as a hardware logic, a local memory 150, and an interconnect interface 160, that is connecting the programmable controller 100 of a respective node with the other nodes, and possibly with other programmable controllers, via the interconnect 130. Alternatively, one or more of inter-connected nodes 120a-120n may comprise only local memory and/or hardware logic, but no CPU.

As such, memory banks of the computing platform 110 are distributed over the different nodes 120a-120n. However, if the platform is constructed as a DSM architecture, the memories can be shared between the different nodes.

The programmable controller 100 is implemented as a hardware module, that is connected to the core 140, the interconnect interface 160, and the local memory 150, such that it can receive and handle commands, and associated data and address, provided from its associated core 140, typically a CPU core, as well as from any of the other cores of the other nodes, via the interconnect interface 160, where each node may comprise a similar programmable controller.

Furthermore, the programmable controller architecture is also adapted to apply a command triggered micro-code method, which relies on micro-code that may be specialized for different types of customized applications.

Each command that may be applied on a programmable controller corresponds to a specific programmable micro-code, or a piece of micro-code, which is a sequence of micro-instructions, comprising a return operation at the end. A command provided to the programmable controller triggers the execution of its corresponding micro-code, which implements or activates a certain micro-function. Due to the fact that the programmable controller executes micro-code, it may also be referred to as a micro-coded controller.

The programmable controller receives commands and associated data and address either from its associated core, or from a core of another node, via the interconnect interface.

A command received by the programmable controller will trigger the execution of a piece of micro-code that corresponds to the command, which results in an execution, addition, modification or deletion of a specific function.

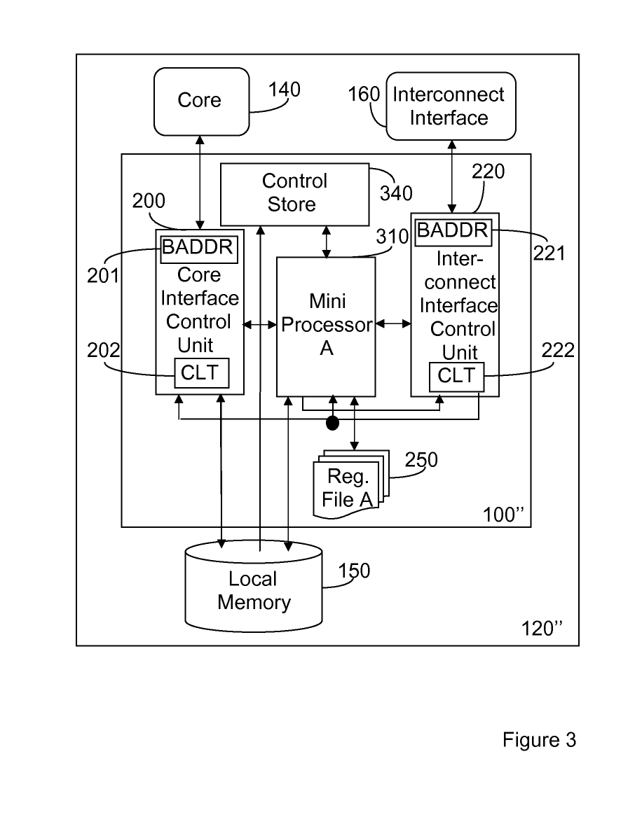

Such a programmable controller that is suitable for implementation on nodes of a multi-node computing platform, e.g. according to the exemplified architecture of FIG. 1, will now be described in more detail with reference to figure and FIG. 3, which refer to two alternative embodiments, respectively. FIG. 2 is an illustration of a programmable controller 100′ of a node 120′, according to one exemplary embodiment, while FIG. 3 is an illustration of a more simplified architecture, according to another, alternative embodiment.

The programmable controller 100′ of FIG. 2 is implemented on a node 120′, which could be any of nodes 120a-n of FIG. 1, and which comprises a first interface control unit 200, that is adapted to connect the programmable controller 100′ with the core 140 of a node 120′ on which the programmable controller 100′ has been integrated. In the present document such a first interface control unit is referred to as a Core Interface Control Unit (CICU). The CICU 200 is adapted to receive commands from core 140 that are requesting for local memory access, and to trigger a first processor, typically referred to as a mini-processor, in the present example mini-processor A 210, because of its light weighted configuration. Mini-processors are commonly used in multi-core contexts, such as the one described above. It is, however, to be understood that the described programmable controller and the associated method steps are not limited to use only in association with mini-processors, but may also be used together with other types of processors that have been adapted in a corresponding way to execute functions in response to trigger commands, according to the suggested method.

The programmable controller 100′ of FIG. 2 also comprises a second interface control unit 220, which may be referred to as an Interconnect Interface Control Unit (IICU). The IICU 220 is adapted to receive commands from the interconnect, i.e. commands originating from another node via the interconnect interface 160, that are requesting for local memory access, and to trigger another processor, here referred to as mini-processor B 230, to execute a function, according to a respective command in a way which corresponds to the CICU/mini-processor A 210 operation. CICU 200 is also adapted to receive replies to remote memory access requests, received from IICU 220, and to forward such replies to core 140, while IICU 220 is also configured to send remote memory access requests to other nodes, and to receive remote memory access replies from the interconnect 130, via the interconnect interface 160, whenever applicable.

When any of the mini-processors 210,230 has been triggered by any of the interface control units 200,220, the respective mini-processor 210,230 is adapted to control a control store 240, which in the present context can be referred to as a functional entity which is operating as an instruction cache for the programmable controller. The interface control units 200, 220 are adapted to load associated micro-code, i.e. micro-code that is identified in accordance with a command, from the control store 240, by checking a Command Look-up Table (CLT) 202,222 of the respective interface control unit.

A respective CLT 202,222 is located in both interface control units. Each such table contains a plurality of entries, which may be referred to as: Command Name, Command ID and the Start Address in the Control Store for the respective command. The first entry, referred to as “Command Name” is a symbolic expression, representing the functional meaning of the associated command, while the “Command ID” is an identifier, comprising a number of digits, which identifies the associated command. The final entry “Start Address” represents the starting address where the associated micro-code is located in the Control Store. When a command, thus the command's ID, arrives at one of the interface control units, the command's ID can be used to find a matching entry in the CLI 202,222 of the respective interface. If a matching entry is found, the micro-code associated with the respective command exists in the control store 240, and can be processed accordingly. The CLT 202,222 is maintained dynamically, which means that the content of the table can be added, removed and replaced. It is to be understood that entries of a CLT are not restricted to the given example, but that they may be configured in other alternative ways, as long as they enable commands to be mapped to an address space where associated micro-code is stored. If, however the associated micro-code is not already accessible from the control store 240 for any of the triggered mini-processors 210,230, the respective control unit 200,220 is adapted to instead upload the relevant micro-code from where the micro-code is located, typically at the local memory 150 of the node 120′, from a remote memory, located at another node, or from an off-chip memory (not shown).

The micro-code uploading is thus performed by the CICU 200 and IICU 220. Such an uploading procedure may be triggered, either by using a special command, or automatically. If the special command method is applied, a programmer may use a special command in a program to trigger the uploading of the relevant micro-code before the corresponding micro-function is executed. If the automatic method is applied, the CICU 200 and IICU 220 can instead automatically upload a corresponding micro-code that does not already exist in the control store 240 with a replacement policy. Mini-processor A 210 and B 230 typically access micro-code from control store 240 via separate ports, indicated as port A 270, and port B 280, respectively, and in a corresponding way, the respective mini-processor 210,230 access the local memory 150 via separate ports, referred to as port A 270′, and port B 280′, respectively.

As indicated in FIG. 2, programmable controller 100′ may also comprise register files, in the present example referred to as register file A 250 and register file B 260, respectively, each of which is used for providing the function of a temporary storage for a respective mini-processor 210,230. The register files 250,260 may be considered as parts of the respective mini-processor 210,230 that can be used by the micro-instructions.

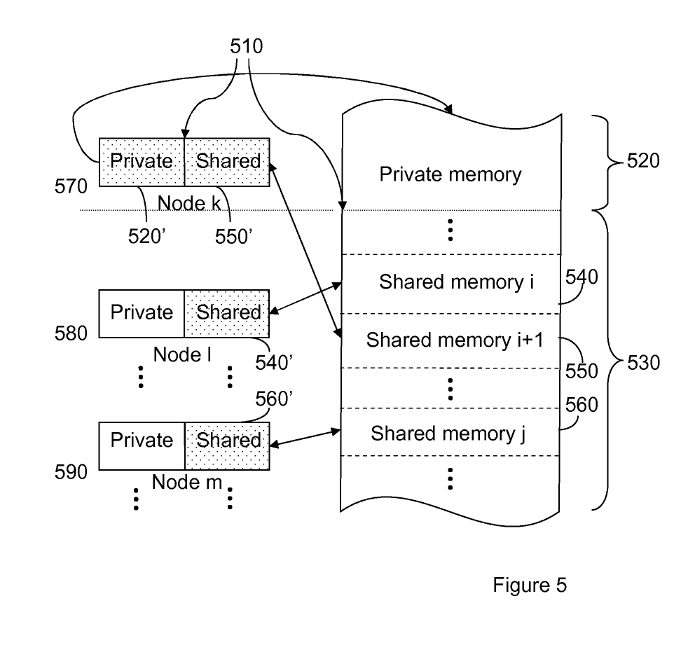

In order to be able to perform V2P address partitioning and translation, the CICU 200 and IICU 220 also comprises a respective Boundary Address Register (BADDR) 201,221. How such a register may be used will be explained in further detail below, with reference to FIG. 5.

Since the controller 100′ of FIG. 2 comprises two mini-processors 210,230, it also has to be provided with a module 290 that is configured to coordinate the two mini-processors 210,230, to enable serialized memory access in cases where requests received from different nodes try to access the same memory region at the same time. Such a module, which may be referred to as a synchronization unit or a synchronisation supporter, guarantees that there is only one access granted at a time for a shared memory region. Such a synchronisation mechanism may typically be achieved by implementing atomic read-modify-write operations, which can be used to implement lock and semaphore functions, according to conventional procedures.

As already indicated above, the suggested programmable controller mechanism may alternatively be implemented as a more simplified architecture. Such an alternative programmable controller, configured according to a second embodiment will now be described in further detail with reference to FIG. 3. According to FIG. 3, a simplified programmable controller 100″ may be configured to comprise a CICU 300 and an IICU 320, but only one mini-processor A 310 that is inter-connected with both the CICU 300 and the IICU 320. In addition, the controller 100″ comprises a control store 340, one register file 350, and a local memory 150. In accordance with the previous embodiment, the CICU 300 is inter-connected with a core 140, while the IICU 320 is connected with an interconnect 130 via an interconnect interface 160.

The single mini-processor 310 is adapted to process commands received both from the core 140 via CICU 300, and from the interconnect interface 160 via IICU 320. Also CICU 300 and IICU 320 are provided with a respective CLT 302, 322, as well as a respective BADDR 300,320, which are used in a way which corresponds to the way in which they are used by the two processor embodiments. There are no principle differences between the function of a programmable controller 100″ having one mini-processor, or a programmable controller 100′ having two mini-processors. The different configurations only differ in performance and cost, wherein the two mini-processor configuration provides higher performance, due to the dual processor configuration, but typically also higher manufacturing costs, while the single processor configuration provides a lower performance, but also lower costs in terms of required silicon area. Even though described either with one or two mini-processors it is to be understood that an alternative programmable controller, that is operable according to the general principles described in this document, may comprise more than two processors. This may e.g. be the case if the programmable controller is provided with more than one interconnect interface.

Consequently, the one or more mini-processors, which are programmable components of a programmable controller, and the control store are configured to interact, such that specific micro-functions, in the form of one or more pieces of micro-code can be executed, after having been triggered by a command. Each piece of micro-code implements a certain function, while a set of commands typically executes a set of functions.

Since the controller is programmable, each function, and its implementation is not fixed as would have been the case if a corresponding function was instead to be implemented as a hardwired solution.

The proposed programmable controller may be implemented as a modular device, which can be built as one hardware component that is an integrated part of a multi-core computer, or computing platform.

The controller is flexible, since functions can be implemented, modified and executed as a result of triggering of software instructions. The same command can be used to implement a different function by replacing it with its corresponding piece of microcode. For each command, its corresponding function is a piece of micro-code. Implementing different functions for the same command requires that the respective micro-code is re-written. After such new, re-written micro-code has been uploaded to the control store, the command will also be associated with the new micro-code in the CLT. New commands can be freely created and micro-coded, and dynamically replaced through the following three steps:
Step 1. Define a command and write micro-code for its function;
Step 2. Upload the micro-code into the control store, typically from the local memory, from a remote or off-chip memory where the micro-code is stored;
Step 3. Update the CLT to make an association between the command and the corresponding micro-code.

An explicit upload-micro-code command may initially be used for uploading of micro-code into the control store, after which the CLT is updated in order to create a new association between a respective command and its corresponding micro-code.

Initially, the relevant micro-code may be stored in the local memory, in a remote memory, or in an off-chip memory, from which it is uploaded into the control store beforehand, or while in demand, i.e. in response to a command, during run-time.

The interface control units, i.e. CICU and IICU, can be referred to as supporting modules that have been adapted to assist a programmable controller in its communication with the core and the local memory, of the node on which the programmable controller has been implemented, and the interconnect, connecting the programmable controller to other nodes. The interface control units are both adapted to receive commands, that may be signaled from the core over wires, or from another node via the interconnect.

The mini-processor and the control store may be implemented in different ways. The internal architecture of a mini-processor may e.g. have different pipeline stages and its instructions may have different size and formats. The control store provides a storage place, suitable for storing micro-code, which could have different sizes in different applications. As described above, a mini-processor that is operating on a programmable controller is configured to interact directly with the control store, with the local memory for local memory accesses, and with the IICU for remote memory requests which are provided from other nodes.

The programmable controller is aimed to solve a set of key problems in a computer system, or platform, where multiple cores/CPUs have been integrated and adapted to enable use of distributed but shared memories, i.e. DSM, and/or MP for inter-process communication. Key issues in supporting DSM are shared memory access, synchronisation, cache coherency, memory consistency, as well as virtual-to-physical address translation (V2P), in case logical/virtual addressing is applied. V2P is an advanced technique which hides the details of physical memory organization from an application program, such that the application only sees the virtual addressing space.

Key functions in supporting MP are channel open and close, channel status query, send and receive with blocking or non-blocking semantics. From the architectural support, and, thus, the programmable controller's perspective, the core functions for supporting the different sets of functions are similar. Some MP related functions are defined as follows:

Open_channel( ): set up a connection called a channel. With a connection established, the communication source and destination are defined and resources, such as e.g. buffers and link bandwidth, may be reserved depending on the type of communication service to be requested;

Close_channel( ): close a connection to disable communication between the source and destination, and release the reserved resources, such as e.g. buffers and link bandwidth, if any;

Send( ): send messages to a destination through an open channel;

Receive( ): receive messages from an open channel.

Specifically, the MP open_channel( ) function is similar to an allocate memory function, applied for DSM. Correspondingly, Close_channel( ) is comparable to de-allocate memory, while Send( ) corresponds to Write( ) and Receive( ) corresponds to Read( ).

Hence, the suggested programmable controller provides an integrated solution for supporting both DSM and MP. The two sets of functions differ mainly from the perspective of the programming model. For DSM, programs running on different nodes use shared variables, enabling inter-process communication, while MP programs do not use shared variables, but use explicit send and receive functions for enabling inter-process communication.

The programmable solution described previously in this document can be used to support the above named functions. Each function is implemented as a set of commands, and for each command, a piece of micro-code is designed. The programmable controller is allowed to add new functions, which would not be possible for a pure hardware solution, where a small change in a function would mean that the entire hardware block that is associated with the respective function would have to be removed, and replaced with another adapted hardware block.

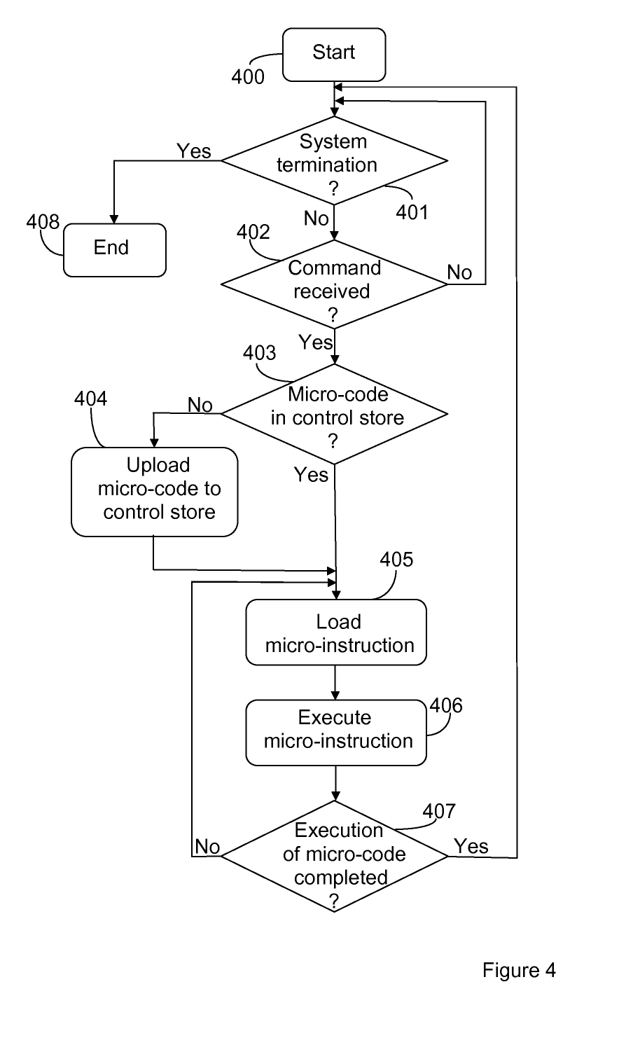

The operation of the controller will now be described in more detail, with reference to the flow chart of FIG. 4. For the bootstrap, the node on which the programmable controller is implemented usually comprises a Read Only Memory (ROM), which typically loads a micro-program from an off-chip memory into the local memory of the programmable controller, after which micro-code may be uploaded to the control store, e.g. for V2P translation. This initial step is represented as an initial step 400 in FIG. 4.

At a step 402, a command transmitted either from the core associated with the programmable controller and received by a CICU, or from another node and received by a IICU. The command triggers the uploading of associated micro-code from the local memory, a remote memory, or an off-chip memory to the control store, unless the relevant micro-code is not already accessible from the control store. This is illustrated with subsequent steps 403 and 404.

As indicated with a next step 405, the triggered mini-processor then generates addresses to fetch the triggered micro-instructions of the micro-code from the control store to the data path of the mini-processor, and in subsequent steps 406 and 407, the mini-processor executes the micro-instructions, until the required execution of a respective micro-code is completed.

This procedure is iterated over the entire execution period of the system, as indicated with conditional step 401. The execution period ends at final step 408.

As an example, managing of address space, in a way which e.g. provides for execution of V2P address partitioning and translation at a programmable controller, that is operable according to the general principles mentioned above, will now be described in further detail with reference to FIG. 5. FIG. 5 is a schematic illustration of a DSM address space 500, or a memory addressing map, of a node, here referred to as node k, of the multi-node architecture.

If V2P is to be applied, each node's local memory region is partitioned into a private part and a shared part. This is achieved by defining a Boundary Address (BADD) 510. Any addresses less than BADD 510 will be referred to as addresses that are associated with private memory access. For node k this memory space is indicated as private memory 520, while any addresses equal to or greater than BADD are addresses associated with shared memory accesses, indicated in the figure as shared memory 550 that is associated with node k. The addresses associated with the shared memory 530 may be located on node k, as well as on other nodes. In the present example, shared memory space i 540 may e.g. be located on node 1, while shared memory space i+1 550 may be located on node k, while shared memory j 560 is located on another node, node m.

The programmable controller is typically adapted to support a re-configurable private/shared memory partitioning, wherein the value of BADD 510 is stored in a register of the CICU and IICU, referred to as a Boundary Address Register (BADDR). There is one BADDR in each control unit of the programmable controller within each node to store the private/shared memory partitioning BADD. The value for the BADDR's of different nodes are the same if all nodes have the same partitioning, while different values may instead be stored and for different nodes if different partitionings are applied.

One important motivation for distinguishing private from shared memory accesses is to speed up local memory accesses, while another reason may be to hide the physical memory organization which is applied in the multi-core computing platform. For the most benefits of application programs, the particular physical memory organization should be transparent so as to facilitate programming efficiency and program portability. Such an approach does however require that all memory accesses use logical or virtual addressing. However, logical addressing involves address translation overhead.

Via the private and shared memory partitioning, physical addressing 520 may typically be used for the local, private memory accesses 520′, while logical addressing 530 may be used for the shared memory accesses, such that in FIG. 5, logical addresses 540 are used for shared memory access 540′ at node 1 580, while logical addresses 550 are used for shared memory access 550′ for node k 570, and logical addresses 560 are used for shared memory access 560′ for node m 590, respectively.

Physical addressing 520 directly accesses the private memory, much faster than logical addressing 530 since a logical address needs a V2P address translation in order for a logical address to be mapped to a physical address. A V2P translation table (not shown) is therefore located in the private part of the local memory.

In addition to static configuration, BADD 510 may be run-time re-configurable, meaning that the programmable controller allows a program to re-configure this value at run-time. This enables run-time adjustment of shared memory pages so as to enable performance speed up and power saving.

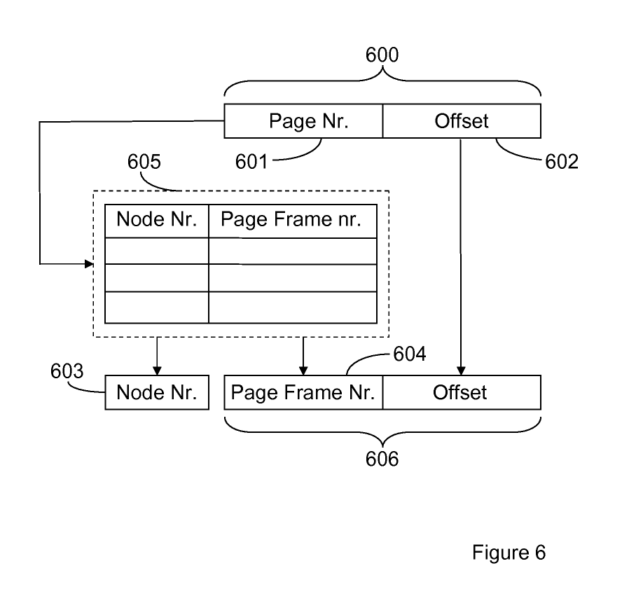

The V2P translation procedure mentioned above will now be described in more detail with reference to FIG. 6, where a logical address 600 consists of two parts, namely a Page number (Page Nr) 601, and a Page offset (Offset) 602. The Page Nr 601 is used as an index to locate its mapped node Identity (Node Nr) 603, i.e. an identity of the node where the physical address is located, and its associated Page Frame Number (Page Frame Nr) 604 in the V2P translation table 605. After a translation has been executed, the physical address 606 can be formed by the Page Frame Nr 604, obtained from the V2P translation table 605 and the offset 602, of the logical address 600.

One possible version of micro-code that may be used for executing a V2P translation by looking-up a V2P translation table, such as the one described above with reference to FIG. 6, is described in table 1. The suggested micro-code of table 1 requires 24 lines of code, and, thus the execution time for the virtual addressing when the microdoce of table 1 is applied will be 24 cycles.

In step 01, the difference between the Logical Address (L_ADDR) and the applicable BADD is calculated and stored in A0. In step 03, the Page Nr and the page offset are extracted from A0 into A0 (A0 is reused) and A1, respectively. Next the index of the Page Frame Nr in the V2P translation table is computed and stored in A3 by adding A0 to V2P HADDR, i.e. the head address of the V2P translation table, as indicated in step 05, and in step 07 the Page Frame Nr is loaded from the V2P translation table into A2. In step 10 the Page Frame Nr of A2 and the page offset of A1 are merged, such that the physical address is obtained and stored in A6, and in step 12 the index of the destination Node Nr in the V2P translation table is computed and stored in A3. In step 14 the relevant destination Node Nr is loaded from the V2P translation table into A4, and in step 17 a branch is executed to the LOCAL line, if the access is found to be local. If remote memory sharing is applicable, in step 19, a best-effort network service is first set for sending this transaction. Then, in step 20 the physical address (A6 obtained in step 10) and DATA are transferred to the respective remote shared memory of the destination node (A4 in step 14) using the network service indicated by the value of A5. In step 22, the V2P microcode execution is finished with a return code 3. The return code of 3 means that, if the memory access is a remote read, the first interface unit, i.e. CICU is informed that data will be returned from the remote node. In step 23, a jump is executed to the start address of the target micro-code.

An alternative, optimized version of micro-code, which is aimed to reduce storage and execution time, but which implements exactly the same function, uses only 18 lines of code. Such a micro-code is illustrated in table 2. To use the optimized micro-code an initial update of the micro-code will be required in the local memory. Such an initial update may be handled in the system boot phase.

While the present invention has been particularly shown and described with reference to exemplary embodiments thereof, it is to be understood by anyone of ordinary skill in the art that various changes in form of details may be made therein without departing from the spirit and scope of the present invention as defined by the following claims. Therefore it is to be understood that the above-described exemplary embodiments have been provided only in a descriptive sense and will not be construed as placing any limitation on the scope of the invention.

TABLE 1

| 01) | sub A0, L_ADDR, BADDR |
|---|---|
| 02) | nop |
| 03) | pfe A0, A1, A0 |
| 04) | nop |
| 05) | add A3, A0, V2P_HADDR |
| 06) | nop |
| 07) | lfw*A3, A2 |
| 08) | nop |
| 09) | nop |
| 10) | pfm A2, A1, A6 |
| 11) | nop |
| 12) | add A3, A3, 3 |
| 13) | nop |
| 14) | lfw*A3, A4 |
| 15) | nop |
| 16) | nop |
| 17) | beq A4, SNODE, LOCAL |
| 18) | nop |
| 19) REMOTE:set A5, 1 | |
| 20) | mp A4, A5, A6, DATA |
| 21) | nop |
| 22) | end 3 |
| 23) LOCAL:jmp START_ADDR | |
| 24) | Nop |

TABLE 2

| 1) | sub A0, L_ADDR, BADDR |
|---|---|
| 2) | nop |
| 3) | pfe A0, A1, A0 |
| 4) | nop |
| 5) | add A3, A0, V2P_HADDR |
| 6) | nop |
| 7) | add A7, A3, 3 |
| 8) | lfw*A3, A2 |
| 9) | lfw*A7, A4 |
| 10) | set |
| 11) | pfm A2, A1, A6 |
| 12) | beq A4, SNODE, LOCAL |
| 13) | nop |
| 14) | A4, A5, A6, DATA |
| 15) | nop |
| 16) | end 3 |
| 17) LOCAL:jmp START ADDR | |
| 18) | nop |

### Abbreviation List

### BADD Boundary ADDress

### BADDR Boundary ADDress Register

### CICU Core Interface Control Unit

### CLT Command Look-up Table

### DSM Distributed Shared Memory

### IICU Inter-connect Interface Control Unit

### MP Message Passing

### QoE Quality of Experience

V2P Virtual-to-Physical

1. A controller comprising a processor, a control store, a first interface control unit for interfacing a local core and a second interface control unit for interfacing one or more remote cores via an interconnect,
wherein the processor is a programmable processor that is adapted to execute, add, remove or modify a function by executing associated micro-code that is obtained via the control store, in response to receiving a command from one of the interface control units.

2. A controller according to claim 1, wherein the command corresponds to an associated programmable micro-code.

3. A controller according to claim 1, wherein the micro-code corresponds to one or more executable micro-instructions.

4. A controller according to claim 3, wherein the executable micro-instructions are defined to implement or activate a specific function.

5. A controller according to claim 1, wherein the function is a memory management function which supports Distributed Shared Memory and/or Message Passing.

6. A controller according to claim 1 wherein the function is a function that relates to at least one of: local and remote memory access, synchronisation, cache coherence, memory consistency, virtual-to-physical address translation.

7. A controller according to claim 1, wherein the first interface control unit and the second interface control unit are adapted to upload an executable micro-code from the local memory to the control store in response to having received a corresponding command at the respective interface control unit.

8. A controller according to claim 7, wherein the first interface control unit and the second first interface control unit further comprises a respective command look-up table, and wherein the control units are further adapted to determine whether an executable micro-code is available at the control store by checking the command look-up table.

9. A controller according to claim 8, wherein, for an executable micro-code, the command look-up table is adapted to comprise: an identifier, which identifies a command, and a start address, which indicates where the micro-code associated with an identified command is located in the control store.

10. A controller according to claim 8, wherein the interface control units are adapted to upload executable micro-code to the control store from any of: the local memory of the controller; a memory of a remote node, or from an off-chip memory, in case the executable micro-code is not already stored at the control store.

11. A controller according to claim 8, wherein the first interface control unit is adapted to forward commands received from the main core of a first node and the second interface control unit is adapted to forward commands received from a node other than the first node.

12. A controller according to claim 8, wherein the controller comprises a first programmable processor, interconnected to the first interface control unit, and a second programmable processor, inter-connected to the second interface control unit.

13. A controller according to claim 8, wherein the first programmable processor and/or the second programmable processor is/are a mini-processor.

14. A controller according to claim 12, further comprising a synchronisation unit, adapted to coordinate the programmable processors, by serializing commands that are simultaneously requesting memory access to the same memory region.

15. An on-chip system, comprising at least two nodes, at least one of which is provided with a controller, according to claim 12.

16. A multi-core computing platform comprising at least two nodes, at least one of which is provided with a controller, according to claim 1].

17. A multi-core computer comprising at least two nodes, at least one of which is provided with a controller, according to claim 1.

18. A method at a controller, comprising a processor, a control store, a first interface control unit for interfacing a local core, and a second interface control unit for interfacing one or more remote cores via an interconnect wherein the following steps are performed at the processor, being a programmable processor:
receiving, from the first interface control unit or the second interface control unit, a command that triggers executing, adding, removing or modifying of a function at the controller,
obtaining, from the control store, micro-code corresponding to the command, and
executing the micro-code, such that the function is executed, added, removed or modified at the controller.

19. A method according to claim 18, wherein the microcode corresponds to one or more executable microinstructions.

20. A method according to claim 19, wherein the one or more executable micro-instructions are defined to implement a specific function.

21. A method according to claim 18, wherein the function is a memory management function which supports Distributed Shared Memory and/or Message Passing for inter-processing communication.

22. A method according to claim 18, wherein the obtaining step comprises the further step of:
uploading the one or more executable micro-code to the control store from any of: the local memory of the controller; a memory of a remote node, or from an offchip memory, in case the executable micro-code is not already stored in the control store.

23. A method according to claim 18, wherein the obtaining step comprises the further step of:
generating the one or more addresses required to fetch the relevant micro-instructions.

24. A method according to claim 18, comprising the further step of:
activating a replacement policy to replace micro-code presently stored in the control store with the micro-code corresponding to the command, in case there is no space available for uploading the micro-instructions to the control store.

25. A method according to claim 18, wherein the executing step comprises the step of executing a function relating to any of: local and remote memory access; synchronisation; cache coherency; memory consistency, or virtual-to-physical (V2P) address translation.

26. A method according to claim 18, wherein the executing step comprises the step of executing a function relating to any of: open, close and query communication channel, send or receive a message.

27. A method according to claim 18, wherein the controller comprises a first programmable processor, inter-connected to the first interface control unit, and a second programmable processor, inter-connected to the second interface control unit, and wherein the method can be executed on any of the processors.

28. A method according to claim 18, further comprising a serializing step for serializing memory access requests in case different commands that are simultaneously requesting access to the same memory region are received by the controller, the serialization step being executed by a synchronisation unit.

29. A method according to claim 18, further comprising a determining step for determining whether an executable micro-code is available at the local control store by checking a command look-up table, the determining step being executed at the first interface control unit or the second first interface control unit.
